(19) United States
(12) Patent Application Publication
(10) Pub. No.: US 2010/0125692 A1
(43) Pub. Date: May 20, 2010

(54) COMPUTER INTERFACE KIT AND COMPUTER INTERFACE DEVICE THEREOF

(75) Inventor: Yen-Ting Lai, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 12/425,432

(22) Filed: Apr. 17, 2009

(30) Foreign Application Priority Data
Nov. 20, 2008 (TW) 97147613

(51) Int. Cl. G06F 13/00

(52) U.S. Cl. 710/302

(57) ABSTRACT

A computer interface kit is provided for communication between a computer and a peripheral device. The computer interface kit includes a computer interface device and a cable. The computer interface device includes an ExpressCard connector connected to the computer, an I/O interface unit connected to the peripheral device, and a circuit unit connecting the ExpressCard connector to the I/O interface unit. The cable electrically connects a DC port of the I/O interface unit with an internal USB port of the computer, whereby the I/O interface unit is powered by a DC voltage from the internal USB port.

### CROSS REFERENCE TO RELATED APPLICATIONS

This Application claims priority of Taiwan Patent Application No. 097147613, filed on Nov. 20, 2008, the entirety of which is incorporated by reference herein.

### TECHNICAL FIELD

The invention relates in general to a computer interface kit and in particular to a computer interface kit having low production cost and improved convenience of usage.

### DESCRIPTION OF THE RELATED ART

ExpressCard technology is the name of a new standard technology introduced by the Personal Computer Memory Card International Association (PCMCIA) in spring 2003. The ExpressCard standard delivers thinner, faster and lighter modular I/O expansion for personal computer users. Since ExpressCard technology has high reliability and features of hot plug and play, it can be widely applied to desktop and notebook computers.

FIG. 1 depicts a conventional ExpressCard device 100 including an ExpressCard connector 110, a circuit unit 120, and an I/O interface unit 130. The ExpressCard connector 110 and the I/O interface unit 130 are electrically connected via the circuit unit 120. The I/O interface unit 130 usually comprises one or several external USB ports 131 to connect peripheral devices thereto. The ExpressCard connector 110 is connected to a computer for data communication between the computer and the peripheral devices.

In accordance with the limitations of the ExpressCard standard specification, the ExpressCard can only provide 1.5/3.3V DC power. However, the 1.5/3.3V DC does not meet the standard 5V DC power required for the Universal Serial Bus (USB). Thus, to solve this problem, an external adapter A is provided and to help supply 5V DC power. However, the adapter A may lead to inconvenience of usage and adversely increase production cost.

### BRIEF SUMMARY

The present invention provides a computer interface kit for communication between a computer and a peripheral device. The computer interface kit includes a computer interface device and a cable. The computer interface device includes an ExpressCard connector connected to the computer, an I/O interface unit connected to the peripheral device, and a circuit unit connecting the ExpressCard connector to the I/O interface unit. The cable electrically connects a DC port of the I/O interface unit with an internal USB port of the computer, whereby the I/O interface unit is powered by a DC voltage from the internal USB port.

### BRIEF DESCRIPTION OF DRAWINGS

The application can be more fully understood by reading the subsequent detailed description and examples with references made to the accompanying drawings, wherein:

FIG. 1 is a perspective diagram of a conventional computer interface device; and

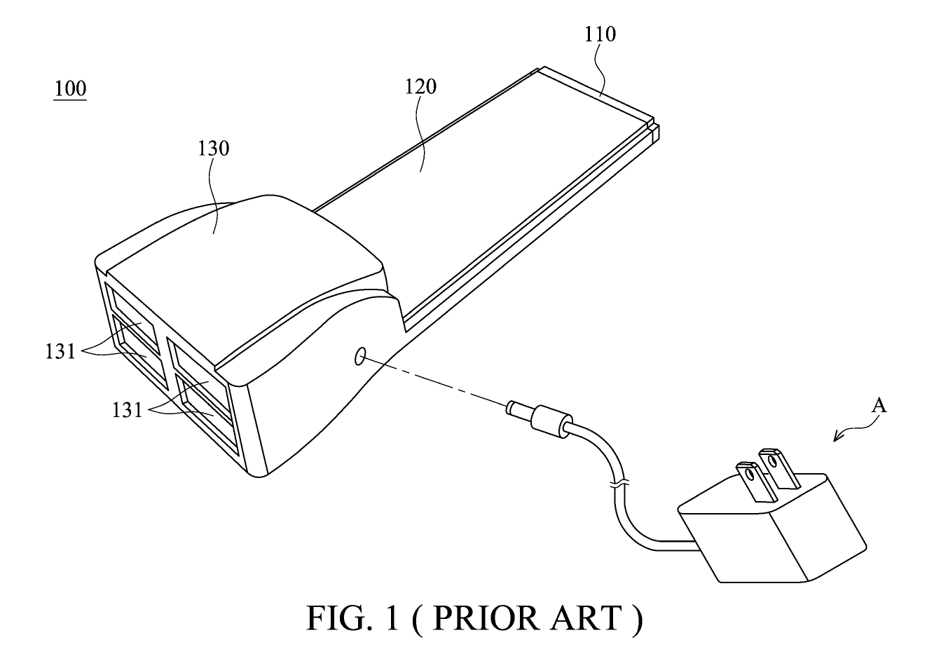

FIG. 2 is perspective diagram of a computer interface kit according to an embodiment of the invention.

### DETAILED DESCRIPTION

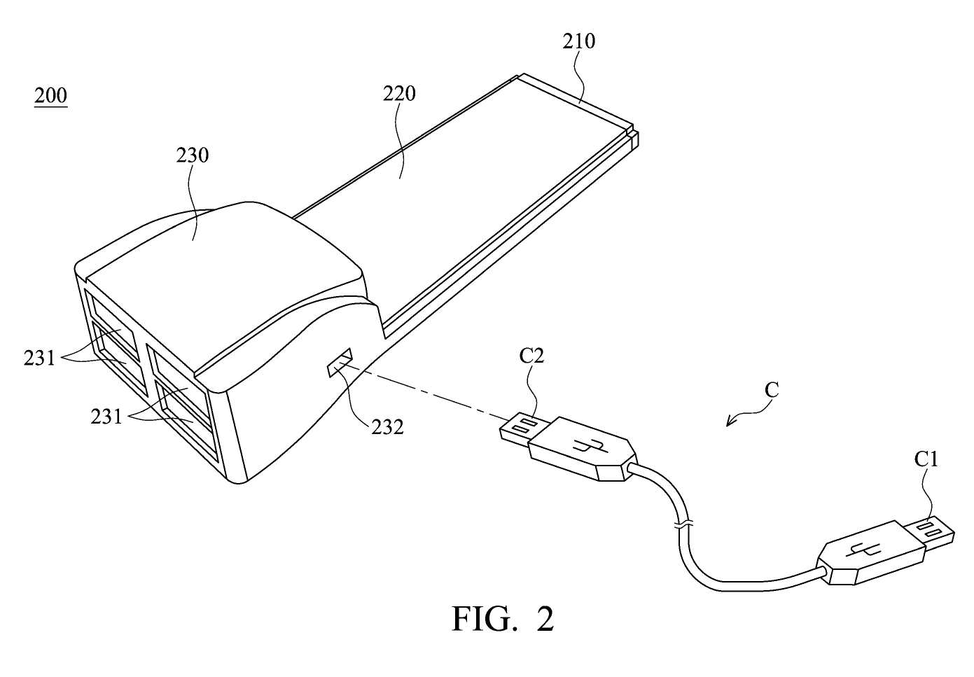

Referring to FIG. 2, an embodiment of a computer interface device 200 comprises an ExpressCard connector 210, a circuit unit 220, and an I/O interface unit 230. The ExpressCard connector 210 and the I/O interface unit 230 are electrically connected via the circuit unit 220. Here, the I/O interface unit 230 comprises at least one external USB port 231 to connect with at least a peripheral device. In some embodiments, the I/O interface unit 230 may comprise one USB hub and several external USB ports to communicate with several peripheral devices.

The computer interface device 200 may support both PCI Express (PCI-e) and USB 2.0/3.0 protocols. During usage, the ExpressCard connector 210 is electrically connected to a computer (not shown) for data communication between the computer and peripheral devices. In this embodiment, since the ExpressCard can only provide 1.5/3.3V DC power, a DC port 232 is provided on the I/O interface unit 230 to accept standard 5V DC power for the external USB ports 231. As shown in FIG. 2, a cable C is provided to electrically connect the DC port 232 with an internal USB port of the computer (not shown), so that the I/O interface unit 230 can be directly powered by DC voltage from the internal USB port of the computer.

Since conventional computer usually has a plurality of internal USB ports, a first connector C1 of the cable C can be electrically joined with the internal USB port of the computer during usage, while a second connector C2 of the cable C is joined with the DC port 232, so that standard 5V DC power is supplied from the computer to the I/O interface unit 230 in order to enable the external USB ports 231 of the I/O interface unit 230. According to this embodiment, since the external USB ports 231 are enabled by 5V DC power from the computer through the cable C, a power adapter and embedded charge pump circuit are not necessary, thus reducing production cost and improving convenience of usage.

In some embodiments, the first connector C1 of the cable C may be a standard A-type USB connector joined with an internal USB port of the computer. Furthermore, the second connector C2 of the cable C may be a standard USB connector, Micro-USB connector, or Mini-USB connector. The type of the DC port 232 corresponds to that of the second connector C2, so that the I/O interface unit 230 is powered by 5V DC voltage through the cable C.

The I/O interface unit 230 may be a PCI-e to USB 2.0, PCI-e to USB 3.0, or USB 2.0 to USB 3.0 converter card for data communication between PCI-e and USB 2.0/3.0 interfaces. In some embodiments, the ExpressCard device 200 can be applied to a standard USB 2.0/3.0 interface adapter or hub, and also be applied to any I/O interface adapter which requires 5V DC power supply for data communication between a computer and peripheral devices.

The invention provides a computer interface kit including a computer interface device and a cable. The computer interface device is electrically connected to an internal USB port of a computer through the cable for receiving 5V DC power from the computer. The invention does not need an external adapter or an embedded charge pump circuit, thus reducing production cost and improving convenience of usage.

While the invention has been described by way of example and in terms of embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation to encompass all such modifications and similar arrangements.

What is claimed is:

1. A computer interface kit for communication between a computer and a peripheral device, wherein the computer has an internal USB port, comprising:
a computer interface device, comprising:
an ExpressCard connector, connecting to the computer;
an I/O interface unit, connecting to the peripheral device and comprising a DC port; and
a circuit unit, connecting the ExpressCard connector with the I/O interface unit; and
a cable, connecting the DC port of the I/O interface unit with the internal USB port of the computer, whereby the I/O interface unit is powered by a DC voltage from the internal USB port.

2. The computer interface kit as claimed in claim 1, wherein the I/O interface unit comprises an external USB port.

3. The computer interface kit as claimed in claim 1, wherein the I/O interface unit comprises a PCI-E to USB 2.0 converter card.

4. The computer interface kit as claimed in claim 1, wherein the I/O interface unit comprises a PCI-E to USB 3.0 converter card.

5. The computer interface kit as claimed in claim 1, wherein the I/O interface unit comprises a USB 2.0 to USB 3.0 converter card.

6. The computer interface kit as claimed in claim 1, wherein the cable has a first connector joined with the internal USB port of the computer.

7. The computer interface kit as claimed in claim 6, wherein the first connector is an A-type USB connector.

8. The computer interface kit as claimed in claim 6, wherein the cable has a second connector joined with the DC port of the I/O interface unit.

9. The computer interface kit as claimed in claim 8, wherein the second connector is a standard USB connector.

10. The computer interface kit as claimed in claim 8, wherein the second connector is a Micro or Mini USB connector.

11. A computer interface device for communication between a computer and a peripheral device, wherein the computer has an internal USB port, comprising:
an ExpressCard connector, connecting to the computer;
an I/O interface unit, connecting to the peripheral device and comprising a DC port, wherein the DC port and the internal USB port are electrically connected through a cable, and the I/O interface unit is powered by a DC voltage from the internal USB port through the cable; and
a circuit unit, connecting the ExpressCard connector with the I/O interface unit.

12. The computer interface device as claimed in claim 11, wherein the I/O interface unit comprises an external USB port.

13. The computer interface device as claimed in claim 11, wherein the I/O interface unit comprises a PCI-E to USB 2.0 converter card.

14. The computer interface device as claimed in claim 11, wherein the I/O interface unit comprises a PCI-E to USB 3.0 converter card.

15. The computer interface device as claimed in claim 11, wherein the I/O interface unit comprises a USB 2.0 to USB 3.0 converter card.

16. The computer interface device as claimed in claim 11, wherein the cable has a first connector joined with the internal USB port of the computer.

17. The computer interface device as claimed in claim 16, wherein the first connector is an A-type USB connector.

18. The computer interface device as claimed in claim 16, wherein the cable has a second connector joined with the DC port of the I/O interface unit.

19. The computer interface device as claimed in claim 18, wherein the second connector is a standard USB connector.

20. The computer interface device as claimed in claim 18, wherein the second connector is a Micro or Mini USB connector.
